(19) United States
(12) Patent Application Publication
(10) Pub. No.: US 2006/0137913 A1
(43) Pub. Date: Jun. 29, 2006

(54) Electromagnetic loop sensor for measuring dynamic loads applied to a roadway by road traffic

(76) Inventor: Mamadou Dicko, Bondoufle (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 10/563,448

(22) PCT Filed: Jul. 2, 2004
(86) PCT No.: PCT/EP04/51340

§ 371 Date: Jan. 4, 2006

(30) Foreign Application Priority Data
Jul. 4, 2003 (FR) 0308219

(51) Int. Cl. G01G 9/00; G01G 19/52; G01G 7/04

(52) U.S. Cl. 177/1; 177/132; 177/210 R

(57) ABSTRACT

The present invention relates to the field of devices for measuring dynamic loads applied to a roadway by road traffic. The subject of the invention is a sensor having an electromagnetic loop designed to produce a signal in response to a pressure applied to its surface, the sensor comprising: an electromagnetic loop designed to radiate an electromagnetic field; and a conducting cover forming an interface between the surface on which the pressure is intended to be applied and the electromagnetic loop, the interface stopping the electromagnetic field radiated by the loop.

### BACKGROUND OF THE INVENTION

The present invention relates to the field of devices for measuring dynamic loads applied to a roadway by road traffic.

It is necessary to know the loads applied to roadways, especially for their maintenance. For this purpose, freeway management companies weigh the dynamic loads applied to roadways by road traffic. This weighing operation is generally performed at the same time as routine measurements, called automatic data collection.

A piezoelectric sensor is generally used to carry out these load measurements. The piezoelectric sensor is formed by a linear piezoelectric cable. This is placed across the roadway in such a way that the wheels on the axles of vehicles being driven on the roadway subject it to pressure as they pass over it. The sensor responds to this pressure by emitting an electrical pulse. The parameters of this pulse are used to determine the dynamic load applied.

### BRIEF SUMMARY OF THE INVENTION

The object of the present invention is in particular to propose an alternative technical solution for carrying out a dynamic weighing operation, this alternative solution being less expensive than that based on piezoelectric sensors.

For this purpose, the subject of the invention is in particular a sensor having an electromagnetic loop designed to produce a signal in response to a pressure applied to its surface, the sensor comprising at least:

an electromagnetic loop designed to radiate an electromagnetic field; and

a conducting cover forming an interface between the surface on which the pressure is intended to be applied and the electromagnetic loop, the interface stopping the electromagnetic field radiated by the loop.

The invention has the advantage of being simple to implement, of requiring no maintenance and of requiring no additional calibration over time once it has been installed and calibrated the first time.

According to one advantageous embodiment, the loop lies approximately in a plane, this plane being approximately orthogonal to the direction in which the pressure is applied. This makes the sensor more sensitive in this direction, thereby increasing the contribution of the useful signal in the measurement.

According to an advantageous embodiment independent of the previous one, the cover forms part of an envelope, the envelope being configured so as to entirely confine the electromagnetic field radiated by the loop. This makes the sensor completely insensitive to the presence of external metal masses.

### BRIEF DESCRIPTION OF THE SEVERAL VIEWS OF THE DRAWINGS

Other features and advantages of the invention will become apparent on reading the detailed description that follows, given by way of nonlimiting illustration and with reference to the appended figures, which show:

FIG. 1, an example of a sensor according to the invention in longitudinal section;

FIG. 2, an example of a sensor according to the invention in cross section;

FIG. 3, an example of electrical signals output by a sensor according to the invention;

FIG. 4, an example of how a sensor according to the invention is installed on a roadway, seen from above;

FIG. 5 an alternative to the example shown in FIG. 4, in which the sensor according to the invention is placed obliquely across the roadway; and

FIG. 6, an alternative to the examples shown in FIGS. 4 and 5, in which the sensor according to the invention is placed perpendicular to the roadway, but only occupying part of it.

### DETAILED DESCRIPTION OF THE INVENTION

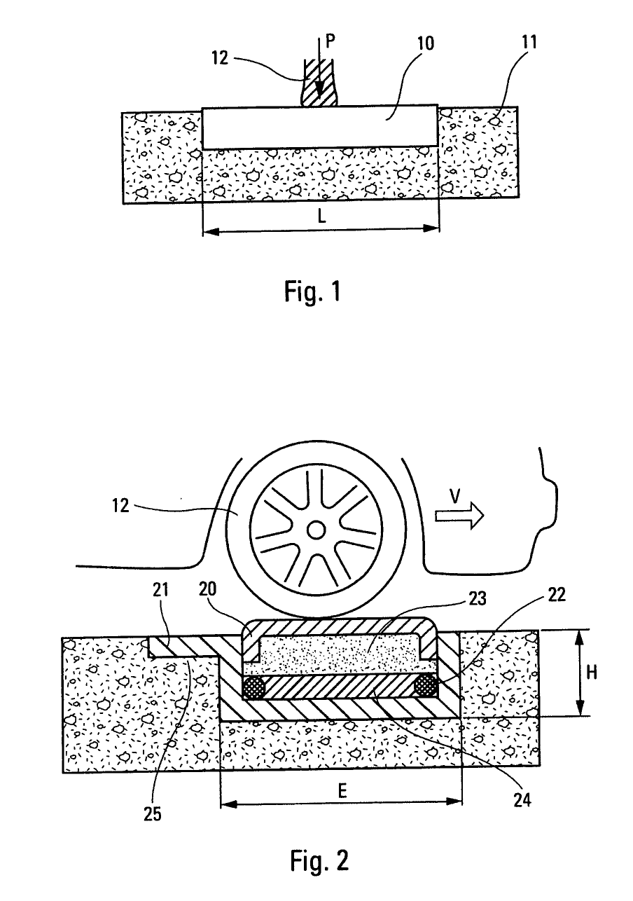

Referring now to FIG. 1, this shows a longitudinal section of an example of a sensor 10 according to the invention. This sensor has a length L and may be placed across one of the traffic lanes of a roadway 11, the sensor occupying for example the entire width of said lane. It may be placed perpendicular to the longitudinal direction of the roadway. In this example, the sensor 10 may have a length L of around 3 m.

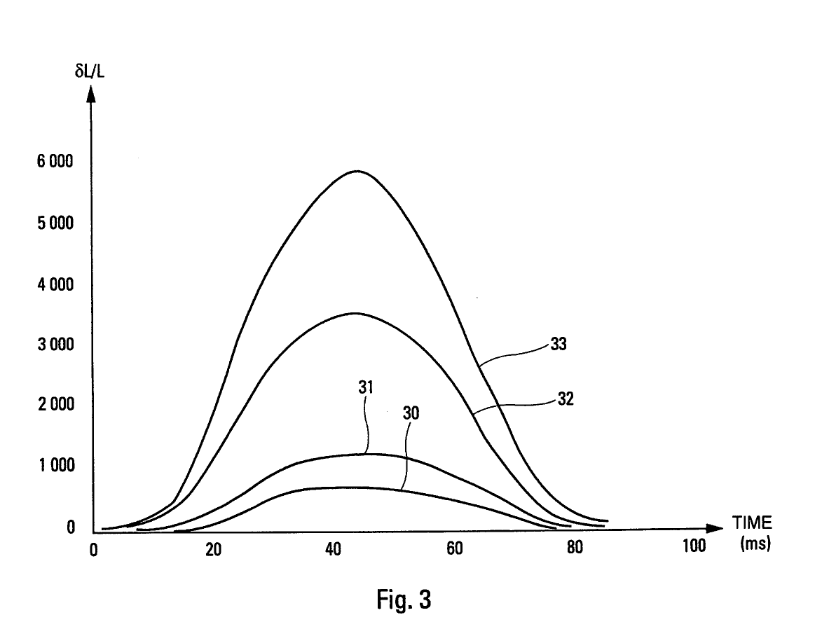

When a vehicle axle 12 passes over the sensor 10, it exerts pressure P on the sensor. In response, the sensor 10 delivers an electrical signal (see FIG. 3) having the form of a pulse. The characteristics of this pulse depend on the compressive force and on the speed of the vehicle, and hence on the dynamic load exerted by the axle on the roadway.

Referring now to FIG. 2, this shows a cross section through the elements of the sensor 10. In this embodiment, the sensor has a U-shaped rigid straight profile 21. The profile has a thickness E, for example of around 10 cm. It has a height H, for example around 4 cm. The profile forms part of the external envelope of the sensor. It allows the sensor to be easily installed, for example in a trench made in the surface layer of the roadway. A rim 25 may be provided on the profile in order to allow it to be fastened to the roadway, for example by means of bolts. The fastening prevents any displacement in the horizontal plane.

The sensor 10 also includes an electromagnetic loop 22 designed to radiate an electromagnetic field. The loop 22 may be a loop having several turns forming a solenoid. It is connected by a return cable to a detection circuit (not shown). The loop has a negligible length compared with its diameter. The loop forms a resonant circuit tuned to the input capacitance of the detection circuit. This assembly forms an oscillator whose resonant frequency is for example between 30 and 150 kHz.

The loop is preferably fastened to the bottom of the profile by means of a rigid filling material 24. This material 24 may consist of a resin.

The sensor 10 also includes a cover 20 placed so as to close off the profile, thus defining an internal volume. The cover has a metal surface. The cover may be formed from a conducting material, such as metal. Preferably, it is formed from a nonferromagnetic material, such as aluminum, copper or one of their alloys. In particular, the cover has the function of isolating the electromagnetic loop from the metal masses placed opposite the cover. In other words, the conducting cover forms an interface between the surface to which the pressure is intended to be applied and the electromagnetic loop, the interface stopping the electromagnetic field radiated by the loop. In this way, the signal delivered by the sensor does not depend on the electromagnetic properties (metal mass) of the vehicles.

The volume left free between the cover 20 and the loop 22 may be occupied by a filling material. By compressing the filling material it is possible for the cover to undergo a vertical displacement. In other words, the cover can move vertically in a translational movement when pressure is applied to the surface of the sensor. Thus, the passage of an axle 12 over the sensor reduces the distance between the cover and the electromagnetic loop, which brings the metal mass of the cover closer to the loop.

The filling material 22 has elastic properties, so that the cover resumes its initial position after an axle has passed. It is preferably made of a strong soft material capable of withstanding the pounding by the traffic. For example, the material may be formed by a foam.

The rigid profile 21 is preferably made of a metal, such as aluminum. It may be made from a sheet 4 mm in thickness. The assembly formed by the cover and the profile forms a metal envelope. This envelope entirely confines the electromagnetic field radiated by the loop 22. The use of a metal envelope makes the signal dependent only on the deformation of this envelope. In this embodiment, this deformation is related only to the displacement of the cover.

In addition, the use of a metal envelope ensures better electromagnetic isolation of the loop. This is useful in particular if the sensor is intended to be used in an environment in which metal masses are present beneath the sensor, such as in concrete roadways.

Referring now to FIG. 3, this shows an example of electrical signals output by a sensor according to the invention.

When a vehicle passes over the sensor, it exerts a compressive force on the surface of the sensor. This compressive force modifies the position and/or the shape of the cover, thereby causing an apparent reduction in the reactance and in the inductance of the loop. This variation may be detected by the detection circuit. The sensor having an electromagnetic loop thus makes it possible to measure parameters that depend on the applied compressive force.

FIG. 3 shows, in the form of curves 30, 31, 32 and 33, an example of the relative variation in the inductance of the loop when a vehicle axle passes over a sensor according to the invention. The variation in the relative inductance may be expressed by the following equation:

$$\frac{δ L}{L} = \frac{{L}_{0} - {L}_{1} ( t )}{{L}_{0}}$$

where L₀ represents the rest value of the inductance of the loop and L₁(t) the apparent value at time t of the inductance of the loop.

Curve 33 corresponds to a normal load, while curves 32, 31 and 30 correspond to this load reduced by 40%, 60%, 80% and 90%, respectively.

The sensor according to the invention can thus be calibrated. This calibration makes it possible to define the height of the peak of the curve as a function of the speed and weight parameters of the vehicle.

To determine the weight, it is therefore necessary to know the speed. The sensor according to the invention is advantageously combined with other sensors for measuring speed.

In another advantageous embodiment, a rough measurement may be taken by assuming that the speed is equal to an average speed, to be determined.

The time width of the curve depends in particular on the speed at which the vehicle is passing, but also on the width of the tires. Consequently, according to one advantageous embodiment of the invention, the area under the curve or the time width of the curve is used to calibrate the sensor according to the invention.

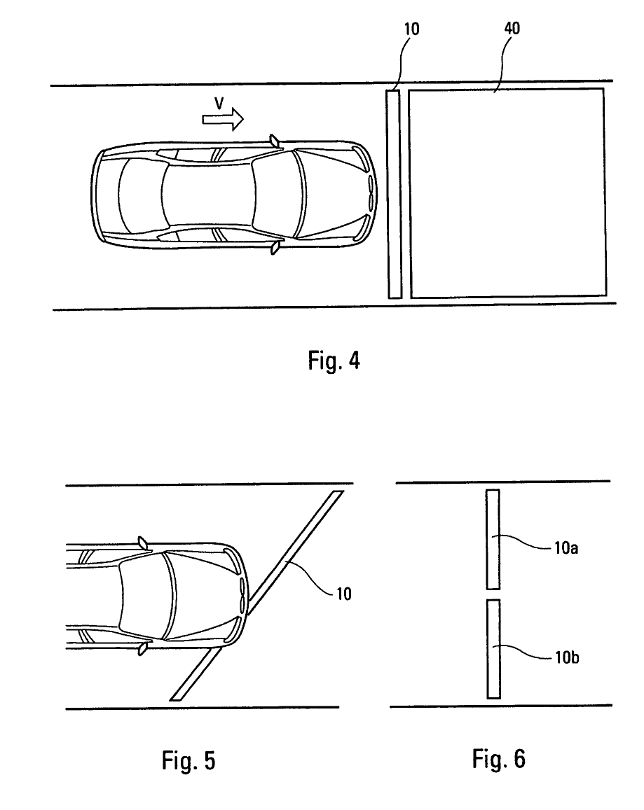

Referring now to FIG. 4, this shows an example of how a sensor according to the invention is installed on a roadway, seen from above.

In this installation example, a first sensor according to the invention is placed transversely over the entire width of the roadway. Its direction is approximately perpendicular to the roadway. A second sensor 40 having an electromagnetic loop for detecting the presence of a vehicle is placed nearby. This second sensor detects the presence of vehicles by detecting their metal masses. It has characteristics known to those skilled in the art. It is mainly distinguished from the sensor according to the invention in that it does not include a conducting cover. It has a length in the direction V in which the vehicles run of around one to two meters. The use of this second sensor allows a presence signal to be generated over the entire period during which a vehicle is passing. This makes it possible to combine the successive dynamic load measurements corresponding to the same vehicle. This is because the first sensor 10 by itself cannot determine whether an axle load measurement is associated with one vehicle or with another.

Referring now to FIG. 5, this shows an alternative arrangement to the example shown in FIG. 4, in which the sensor according to the invention is placed obliquely across the roadway. This allows weighing to be carried out wheel by wheel. In addition, if another sensor according to the invention is added, placed perpendicular to the roadway (as shown in FIG. 4), the lateral location of the vehicle on the roadway can be deduced therefrom by determining the speed and the difference in time for the left and right wheels of the vehicle to pass over the two sensors according to the invention.

Referring now to FIG. 6, this shows an alternative arrangement to the examples shown in FIGS. 4 and 5 in which the sensor according to the invention is placed perpendicular to the roadway, but occupies only part of it. For example, the lane may be divided into two halves in the width direction, and a sensor 10a, 10b placed on each half. This allows wheel-by-wheel weighing to be carried out.

Of course, the invention is not limited to these embodiments.

The sensors shown in these embodiments are trench sensors, that is to say sensors incorporated in the roadway. The invention also applies to surface sensors, that is to say to sensors placed on top of the roadway.

In these embodiments, the electrical signal is produced by elastic displacement (translation) of a rigid cover. Alternatively, it is possible to provide a deformable cover. The deformation of this cover is then elastic. In this case, the electrical signal is produced by the deformation of the cover. Thus, it is possible to provide a cover that can move and deform elastically when pressure is applied to the surface of the sensor. Whatever the case, the deformation and/or displacement of the cover causes a conductor (forming an integral part of the cover) to move closer to the electromagnetic loop.

The cover is not necessarily formed entirely from one and the same material. For example, it may essentially be made of a material selected for its mechanical properties (strength, elasticity, etc.), this material being covered with a metallization layer in order to give it the desired electromagnetic properties.

For example, in the embodiment shown in FIG. 2, the cover 20 may be replaced with a layer of polymer containing graphite particles. This layer of polymer thus forms a deformable cover. This deformable cover (which can deform by being compressed) may be placed on a layer of polymer containing no graphite particles. The sensor thus comprises three layers, namely a first layer 24 of rigid filling material, a second layer 23 of polymer containing no graphite particles and a third layer of polymer containing graphite particles. The third layer of polymer thus forms the cover of the sensor according to the invention.

In the embodiment shown in FIG. 2, the volume left free between the cover and the loop is occupied by a filling material. More generally, this volume may be occupied by any compressible substance or device. Thus, the flexible material may be replaced with a gas. In this case, the sensor preferably includes a probe for measuring the temperature so as to correct the variations in pressure of the gas corresponding to the variations in temperature.

1-10. (canceled)

11. A dynamic weighing system, comprising a combination of at least one speed measurement sensor and a sensor having an electromagnetic loop designed to produce a signal in response to a pressure applied to its surface, the sensor having an electromagnetic loop comprising:
an electromagnetic loop designed to radiate an electromagnetic field; and
a conducting cover forming an interface between the surface on which the pressure is intended to be applied and the electromagnetic loop, the interface stopping the electromagnetic field radiated by the loop.

12. The system as claimed in claim 11, wherein the loop lies approximately in a plane, this plane being approximately orthogonal to the direction in which the pressure is applied.

13. The system as claimed in claim 11, wherein the cover forms part of an envelope, the envelope being configured so as to entirely confine the electromagnetic field radiated by the loop.

14. The system as claimed in claim 11, wherein the cover is configured so as to deform when pressure is applied to the surface of the sensor, the deformation of the cover being elastic.

15. The system as claimed in claim 11, wherein the cover is configured so as to move elastically when pressure is applied to the surface of the sensor.

16. The system as claimed in the claim 15, wherein the displacement of the cover includes a translation toward the loop.

17. The system as claimed in the claim 16, wherein includes an elastic material placed between the cover and the loop, said elastic material being compressed in order to allow displacements of the cover.

18. The system as claimed in the claim 17, wherein the elastic material is formed by a resin.

19. The system as claimed in claim 11, wherein the cover is made of a nonferromagnetic material.

20. The system as claimed in the claim 19, wherein the material forming the cover is aluminum, copper or one of their alloys.
